(19) United States
(12) Patent Application Publication
(10) Pub. No.: US 2019/0272565 A1
(43) Pub. Date: Sep. 5, 2019

(54) System and method for providing contents on a portion of display screen of a mobile device

(71) Applicant: Rabindra K Roy, Oakton, VA (US)

(72) Inventor: Rabindra K Roy, Oakton, VA (US)

(21) Appl. No.: 15/908,859

(22) Filed: Mar. 1, 2018

(51) Int. Cl. G06Q 30/02

(52) U.S. Cl. CPC G06Q 30/0267; G06F 3/0484; G06Q 30/0277

(57) ABSTRACT

A system and method for displaying advertising contents on a portion of display screen of a mobile device. The display screen of the mobile device is divided into a first portion and a second portion, where a physical display driver of the display screen is configured to divide into two or more logical display drivers by a software application to drive the contents on the first portion and the second portion simultaneously. The first portion is a normal user initiated application display and the second portion is an advertising application display. The purpose of the present invention is that the advertising application display can be driven by any content by either the mobile device manufacturers (MDMs) or communication service providers (CSPs) or mobile virtual network operators (MVNOs). The portion of the advertising application display can be used for monetizing by the device manufacturers or the mobile operator for delivering the advertising content for advertisers.

### FIELD OF INVENTION

The present invention relates to a mobile communication terminal for advertisements and emergency messages, more particularly a system and method for displaying advertising contents and emergency messages on a portion of a display screen which is independent of the main display screen of the mobile communication terminal.

### BACKGROUND OF THE INVENTION

With the rapid development of mobile communication technology, mobile device users have been increasing day by day. The mobile devices are widely used with constantly improving wireless communications technology. Mobile communication has brought in communication convenience to people but has also brought in various other uses such as business, marketing, and advertising tool aimed at individual user.

Currently, advertising on mobile devices is very widely used. For example, many companies advertise and make special offers directly on the display of the mobile devices. Some companies also provide Apps that advertise goods and services, and facilitate purchase and sale of those goods and services, to mobile users.

In mobile device advertisements, advertising contents are delivered to the user in many forms including advertising banners, text links (SMS), multimedia, and other methods, such as, multimedia services (MMS), advertising within mobile games and mobile videos.

Further, a method for mobile advertisements using the advertising contents, along with free applications are known in the prior arts, where the advertising contents are essentially forced upon the users, who download a free application or a game. These kinds of advertisements do generate some revenue, but, in general, these methods are less effective.

The effectiveness of a mobile advertisement is measured in a variety of ways. The two main measurements are views by the user and click-through of the contents by the user. In the advertising world, advertiser pays for the advertising service in exchange for a space to present advertising content to one or more users. Advertising may only be effective if the user is interested in the contents, which may be deemed appropriate, relevant, or interesting for a particular user, thereby increasing the likelihood of a click-through.

Accordingly, the way in which advertising contents are gathered and distributed is generally done with the end user in mind. When advertising through mobile devices the advertising content is traditionally directed to a likely user who may be interested for the delivered content.

Although the user may have access to such broadcasted contents and may be able to access a particular content but various other uses of the mobile devices may command the user's attention at various times during a given day. As such, advertising on a mobile device can be more challenging than simply associating advertising content with a given platform or within a particular mobile application.

It could be useful for the advertiser's confidence if they can ascertain that they are advertising in the most appropriate space, and to their target audience, at least in a general sense. But this may only work when advertising is done according to a schedule or the advertising content is visible on a particular portion of the display screen of the mobile devices that has a specific purpose or target user's attention.

Advertisements are used to persuade users to purchase or sell a particular product or service or to deliver an advertiser's message to shape the opinion of the target users on a particular topic or view. Generally, advertisements are to be displayed in the portion of a device, which is easily seen or accessed. In order to reach as many potential consumers as possible, advertisers typically pay an intermediary such as a media company or content publisher. In 2016, advertisers paid more than $500 billion to media companies to advertise their messages to users in the United States alone.

The advertising companies receive huge amounts of fees from the advertisers, however, the mobile device manufactures (MDMs) do not get any portion of that amount for the advertising contents that are displayed on the mobile device manufactured and sold by them. Similarly, the Communication Service Providers (CSPs), who provide the most critical part of connectivity of the mobile device to enable delivery of the advertising content, do not get paid any sum either, by the advertisers or social network platforms such as, Facebook®, Instagram®, and Twitter®.

One of the biggest challenges in insertion of advertisement content by the communication Service Providers (CSPs) or the mobile virtual network operators (MVNOs) on a page being viewed on mobile device is the fact the most desirable contents are on the webpages of companies like Facebook®, Google®, Youtube®, and Twitter®. This end-to-end encryption prevents the communication Service Providers (CSPs) to insert any advertisement

Thus, there is a need for a solution that enables the mobile device manufactures (MDMs) and the Communication Service Providers (CSPs) to display specific advertisements directly to the mobile device user, and participate in the advertising revenues that are being generated through the use of mobile devices and the Communication Service Provider's (CSP's) networks.

The present invention provides a novel way to drive a specific portion of the display screen of the mobile devices with contents chosen by the Communication Service Providers (CSPs). This content is independent of the content shown by the social network applications or other third party applications being used by mobile device user at that time. The selected specific portion of the display screen can be driven by any content by the Communication Service Providers (CSPs), including a mobile virtual network operator (MVNO). The dedicated portion of the display can be used for monetizing by the Communication Service Providers (CSPs) for advertising contents to the target users. Since this capability requires cooperation between Communication Service Providers (CSPs) and mobile device manufactures (MDMs), the Communication Service Providers (CSPs) may choose to a revenue share model with the mobile device manufactures (MDMs).

### SUMMARY OF THE INVENTION

According to the present invention, a method and system for displaying advertisements, independent on the content of the app being used by the user, on a mobile device is provided.

In one aspect of the present invention, a mobile device is being configured for pushing specific advertising contents, Communication Service Provider (CSP), on a portion of the display screen. The display screen of the mobile device is divided into a first portion and a second portion. The first portion is the advertising application display and the second one is the normal user initiated application display. In other words, the display screen is divided into the advertising application display and the normal user initiated application display, where the physical display driver of the display screen is configured to divide two or more logical display drivers by embedded software control to drive the contents on the first portion and the second portion independently. It may be noted that at least two portions may be used such that one portion contains the advertising application display and other portion contains the normal application display.

Further in another aspect of the present invention, the first portion containing a user initiated application display having full screen control and the second portion containing an advertising application display having limited screen control or no screen control,

Further in another aspect of the present invention, the advertising application display i.e., the second portion according to one or more predetermined criteria to display user-specific advertising contents. Therefore, the mobile device of the present invention enables contents from different sources to be displayed simultaneously on each portion of the display screen.

Further, the display screen is divided into two display portions wherein the advertising application display is given an independent portion for displaying advertising contents initiated by the mobile device manufacture (MDM) or the Communication Service Provider (CSP).

The advertising application display is given limited or no user screen control or that is outside of the user's control. Such use of screen control is advantageous for controlling when, how and under what circumstances advertising contents are provided to the user, independent of the full interaction capabilities provided for the normal application display.

In another aspect of the present invention, the advertising application display can be driven by any content by either the mobile device manufacture (MDM) or the communication Service Providers (CSPs) or the mobile virtual network operators (MVNOs). The portion of the advertising application display can be used for monetization by the mobile device manufacture (MDM) or the Communication Service Provider (CSP) for advertising contents for advertisers targeting selected users.

The screen control for the advertising application display will be controlled by the mobile device manufactures (MDM) or the communication Service Providers (CSP) or the mobile virtual network operators (MVNO), is monetizing the advertising portion of the display. Further, the contents can be manipulated, resized, closed, opened or otherwise modified in appearance by the MDM or CSP or MVNO. Further, a user is given limited screen control for the advertising application display such that, any contents are shown thereon is controllable in a limited way by the user.

In another aspect of the present invention, the initiation and duration of the advertising contents can be strictly controlled by the MDM, CSP, or MVO, according to specific rules and intervals, given that the opportunity to collect direct advertising revenue is the main objective. In other words, the advertising content is filtered by the advertising content server connected wirelessly to the mobile device depending upon the user's preference and activities.

In another aspect of the present invention, the various different levels of screen control can be implemented to add further value to the MDM, CSP, or MVNO and in return better subsidies and discounts for the end user either in the form of device upgrades or in the case of CSP and MVNO, offering lower charges for network usage. This, in combination with the inherent anonymity, enables such systems to provide an improved advertising experience for both the advertising content providers and the users.

The present invention removes the barrier of monetizing advertising opportunity by MDMs, CSPs, or MVNOs for contents which are encrypted end-to-end, for example, Facebook®, Whatspp®, and Youtube®.

In another aspect of the present invention, the advertisement provider server may provide advertisement contents based on any one or a combination of two or more of location information, activity information, and personal information of the user.

### BRIEF DESCRIPTION OF THE DRAWING

The following invention will be described with reference to the following drawings of which:

FIG. 1 is display screen of a mobile device according to an embodiment of the present invention;

FIG. 2 is a block diagram illustrating an exemplary mobile device according to an embodiment of the present invention;

FIG. 3 is a system diagram of one configuration for location based advertising contents retrieval according to an embodiment of the present invention;

FIG. 4 is a system diagram of another configuration for location based advertising contents retrieval according to an embodiment of the present invention;

FIG. 5 is a system diagram of yet another configuration for location based advertising contents retrieval according to an embodiment of the present invention; and

FIG. 6 is a flow diagram illustrating a method for advertising contents according to an embodiment of the present invention.

The drawing figures do not limit the present invention to the specific embodiments disclosed and described herein. The drawings are not necessarily to scale; emphasis instead is placed upon clearly illustrating the principles of the invention.

### DETAILED DESCRIPTIONS

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The terms “including”, “comprising” and “containing” denote the presence of one or more components or elements that are part of the present disclosure. Following below are more detailed descriptions of a system and method for displaying advertising contents on a portion of a mobile communication terminal or mobile device.

The terms “advertisements” and “advertising contents” may include, but not limited to, a multimedia file containing texts, pictures, photographs, animations, music, speech, videos, or 3D videos.

It should be understood that the term “mobile device” as mentioned herein generally refers to mobile phones, smart phones, tablets, wearable devices, also known as mobile communication terminals

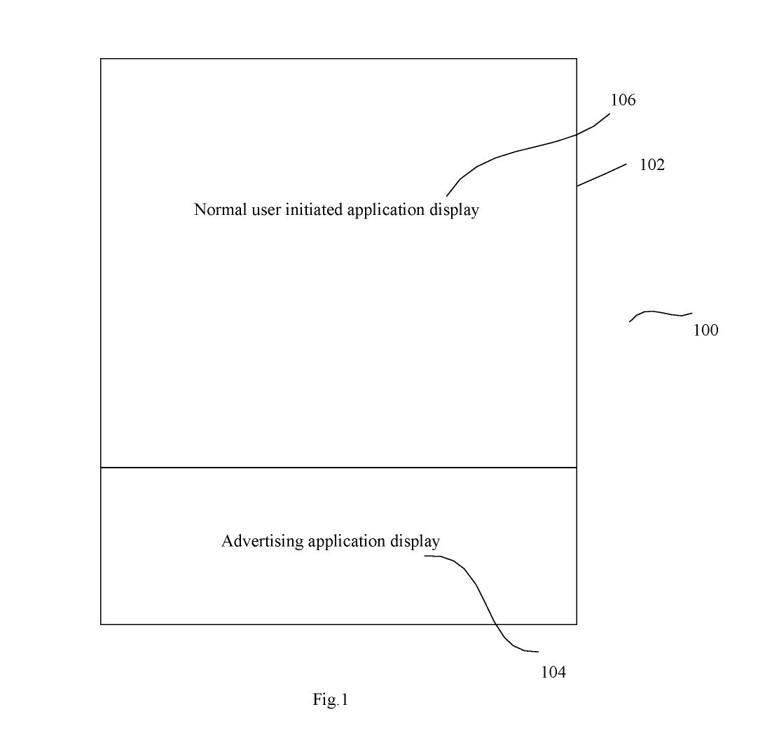

Referring now to FIG. 1, in one embodiment the present invention provide a mobile device 100 having an independent portion on the display screen 102 for displaying advertising contents. As can be seen in FIG. 1, an interface of the display screen 102 of the mobile device 100 comprises a first portion 106 also referred as a normal user initiated application display and a second portion 104 also refereed as an advertising application display. The display screen 102 is divided into the normal user initiated application 106 and the advertising application display 104, where a physical display driver of the display screen 102 is configured to divide into two logical display drivers by a software application to drive the contents on the first portion 106 and the second portion 104 independently.

It can be seen that the display screen 102 is divided into the normal user initiated application display 106 and the advertising application display 104. Further, it may be noted that two or more portions may be used such that a one portion contains the normal application display 106 and another portion contains the advertising application display 104. The display screen 102 is divided into two separate display portion wherein the advertising application display 104 is given an independent portion of the overall physical display screen 102 from the normal application display 106. As described in more detail below, the advertising application display 104 is given limited or no user screen control and the display screen 102 is divided, that is outside of the user's control, as exemplified in FIG. 1. Such use of screen control is advantageous for controlling when, how and under what circumstances advertising contents are provided to the user, independent of the full interaction capabilities provided for the normal application display 106. Further, as shown in the FIG. 1 the display screen 102 of the mobile device 100 comprises an advertising application display 104 at lower end and normal user initiated application display 106 at upper end. However, this is merely for exemplary illustrative purpose; the choice of the space on the display screen 102 may be different without departing from scope of the invention.

In general, the advertising application display 104 can be driven by any contents by the MDM, CSP, or MVNO. The portion of the advertising application display 104 can be used for monetizing by the MDM or CSP for advertising contents for advertisers.

The screen control for the advertising application display 104 may be controlled by the MDM, CSP, or MVNO, and they can consider the extent to which contents are being displayed on that portion. Further, the contents can be manipulated, resized, closed, opened or otherwise modified in appearance by the MDM, CSP, or MVNO. Further, a user is given limited screen control for the advertising application display 104, any contents running thereon the user is able to interact with those contents in a limited way. As will be discussed below, it has been recognized that different levels of screen control can be given to separate and distinct portions of the display screen to enable advertising contents to be provided to the user under control of the MDM, CSP or MVNO. Again, the initiation and duration of the advertising contents can be strictly controlled by the MDM, CSP, or MVNO, according to specific rules and intervals; given that the opportunity to collect direct advertising revenue being the main objective.

It can thus be seen that additional and changing levels of screen control can be imposed to add further value to the MDM, CSP, or MVNO and in return better subsidies and discounts for the end user either in the form of device upgrades or, in the case of CSP and MVNO, offering lower charges for network usage. This, in combination with the inherent anonymity, enables such systems to provide an improved advertising experience for both the advertising content providers and the users.

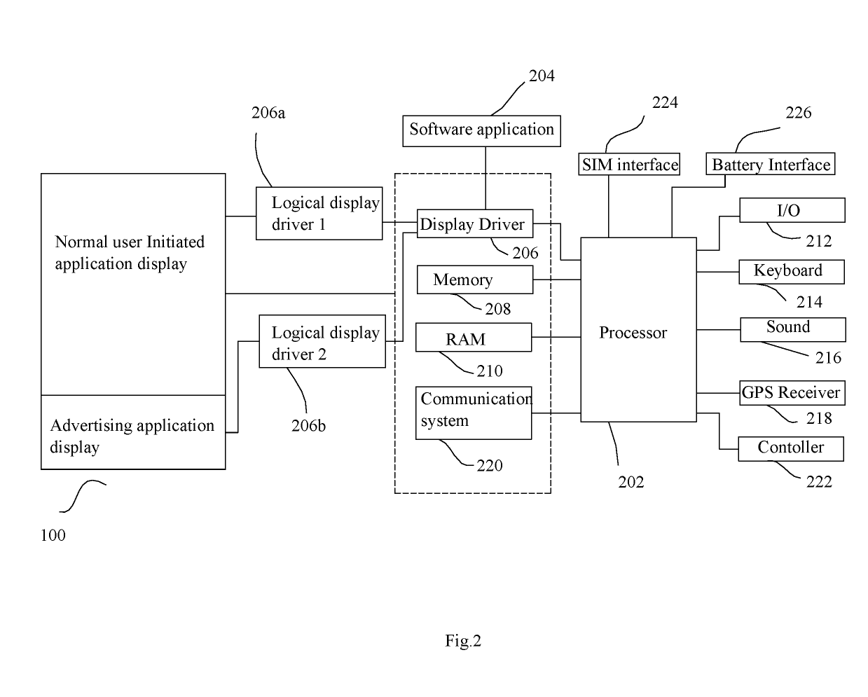

Now referring to FIG. 2, shown therein is a block diagram of an exemplary embodiment of the present invention. The mobile device 100 comprises a number of components such as a processor 202 that controls the overall operation of the mobile device 100. In one preferred embodiment of the present invention, the mobile device 100 comprises embedded software program or a software application 204 that may divide the display driver 206 into two or more logical display drivers 206a, 206b. Therefore, the logical display drivers 206a, 206b may drive two or more portions of the display screen independent of each other. The processor 202 also interacts with additional subsystems such as a memory 208, a Random Access Memory (RAM) 210, an auxiliary input/output (I/O) subsystem 212, a keyboard 214, a sound system 216, a GPS receiver 218, and a communication subsystem 220, performing communication functions, including data and voice communications. The software application 204 is configured to drive the portion of the advertising application display 104 with advertising contents. Further the software application 204 is configured with short-range communications, and other device for retrieving advertising contents based on location and user's activity that is relevant to the users. It will also be understood by persons skilled in the art that the embodiments described herein are intended to use any other suitable standards.

The mobile device 100 can send and receive communication signals over the wireless network after required network registration or activation procedures have been completed. Network access is associated with a subscriber or user of the mobile device 100. To identify a subscriber, the mobile device 100 may use a subscriber module component or “smart card” is to be inserted into a SIM interface 224 in order to communicate with a network. The mobile device 100 is a battery-powered device and includes a battery interface 226 for receiving one or more rechargeable batteries.

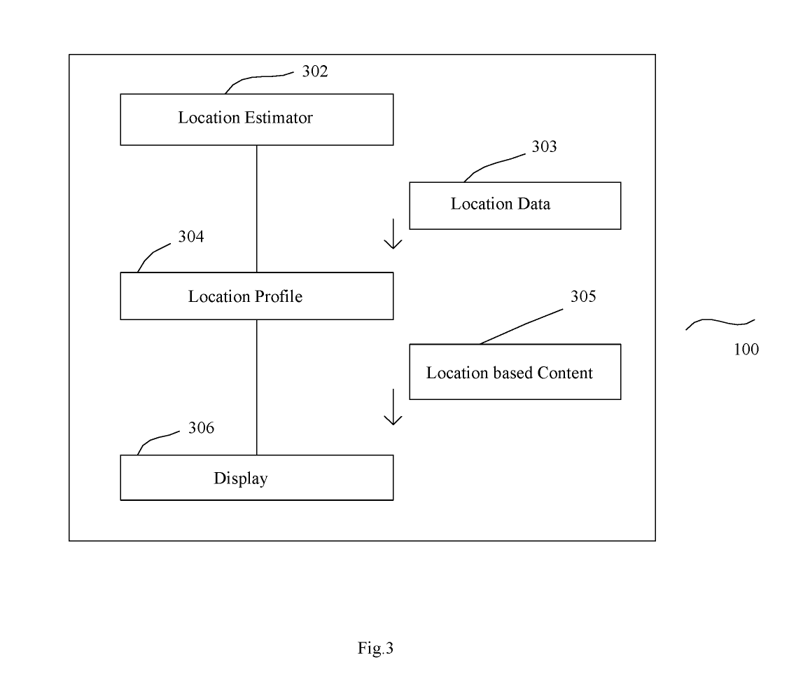

Referring now to FIGS. 3 to 5, various configurations are shown for providing location data 303 of the mobile device 100 in order to obtain or receive user-specific content, herein referred to as location based content 305. The systems shown in FIGS. 3 to 5 are utilized to localize information such local events, offers in the particular area the user presents. The mobile device is configured with location estimator 302, based on location the user the mobile device 100 is programmed to create location profile 304 of the user. The location profile 304 contains details about the places the user may have visited. Based on location profile 304 of the user, the advertising contents are delivered to the display 306. Further, the location profile 304 include the details that the user may be interested to visit based on the users recent activities. Further, the system can be used alone to provide location data 303 that relates only to the physical location of the mobile device 100 or along with user-input related location data 303. Such user-input related location data 303 can be used for filtering certain location based content 302 such as advertisements for a user based on locations specified by user preferences (e.g. as specified in the user location profile 304 rather than or in addition to the physical location of the mobile device 100). In this way, for example, a user can receive news from their home city even when travelling. Although the systems shown in FIGS. 3 to 5 include simplified block diagrams showing only certain components involved in generating location data 303 and location based content 305, it will be appreciated that these configurations can be implemented with the systems and operations thereof as described above as well as other similar systems.

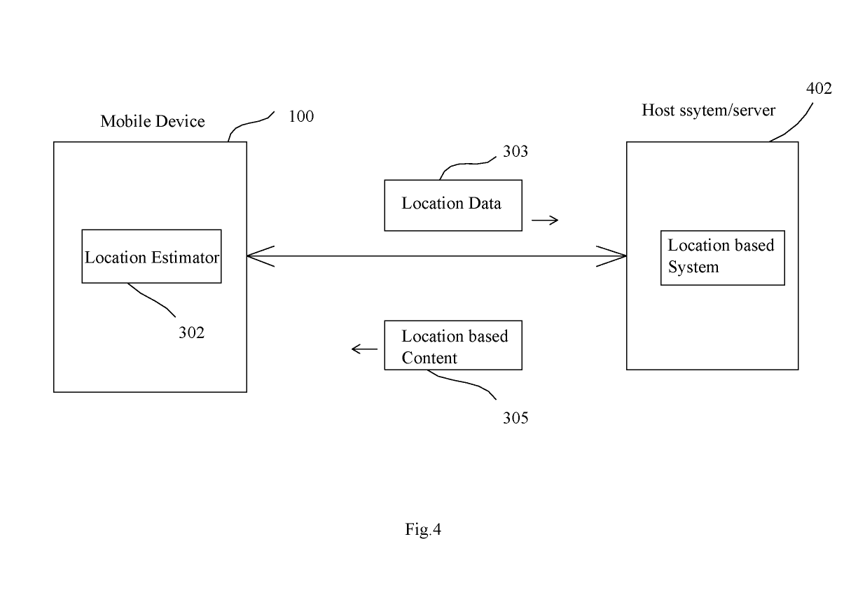

Further as shown in FIG. 4, is a system diagram of another configuration for a location estimator 302 in a mobile device 100 that provides location data 303 to a host system or server 402 and receives location based contents 305 from the host system or server 402 in accordance with one embodiment.

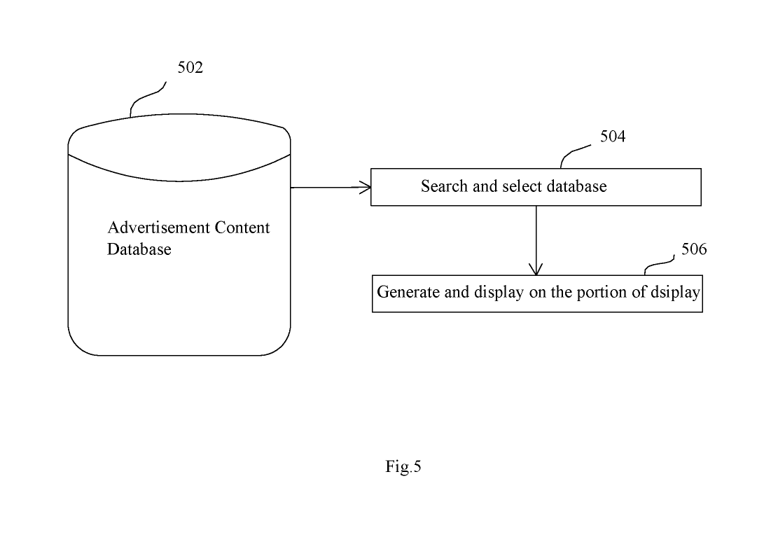

Display of advertisements is triggered by unlocking of the user mobile device 100. As such, advertisements will be displayed on the user device 100 each time it is unlocked. As shown in FIG. 5, this results in retrieval of an advertisement from the database 502 through background services which search and select the advertising contents 504 and the advertising contents is then displayed 506 in the advertising application display 104 on the user device 100. In certain embodiments, the advertisement does not have to be displayed each time and instead the advertisement may be displayed in one or more of the following timings: a portion of the times the user device is unlocked, a substantial portion of the times the user device is unlocked, a predetermined set of times the user device is unlocked or random times the user device is unlocked. The searching of the advertisement contents 506 may be performed by using attributes of the respective contents, such as contents name, producer, and provider. After searching the advertisement contents, the searched contents are displayed on the advertising application display 104 of the user's smart phone.

However, in certain exemplary embodiments the advertisements, a portion a single advertisement or a plurality of advertisements may be displayed on subsequent unlocking of the display screen 102. Also, in that case, a set of advertisements or a subset of advertisements pushed to the mobile device 100 may be removed after a default period of time.

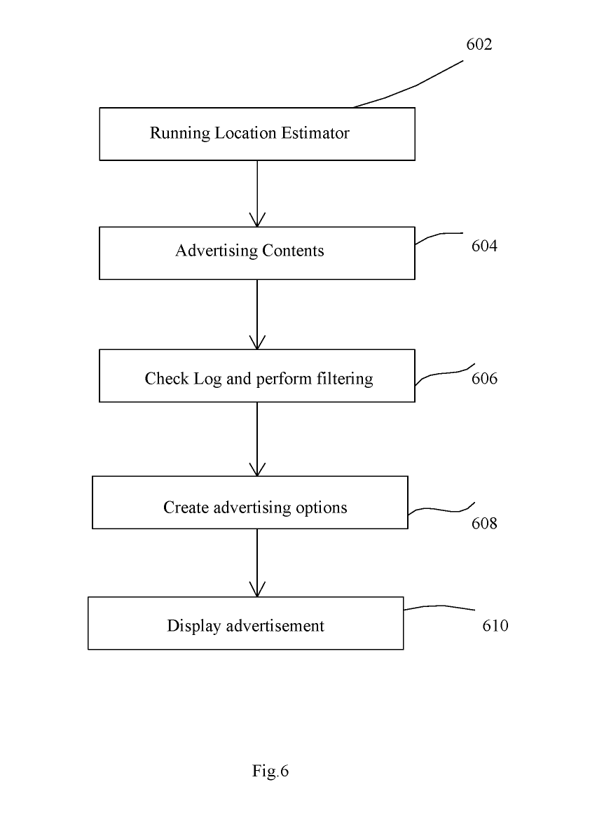

It may be noted that the flow diagram shown in FIG. 6 is more applicable to the software application 204 of the present invention for displaying advertising contents on the advertising application display 104 of the mobile device 100. It will be appreciated that certain operations may be done in a different order or in parallel with others operations, in particular if performed using the configuration of the programmed sequences. When the mobile device is unlocked or in active state obtains location data of the mobile device 100 by running location estimator 602. In this example, the advertising contents 604 that is received from the advertisements database, performs check log and filtering 606 by the service end before being added to the advertising application display 104. Such checking and filtering 606 is performed using both location and user preference data. The advertising content server initiates or obtains location data 303 from the location estimator 302 as described above. The advertising content server also accesses or receives data from the advertising profile and if applicable, the location profile 304 to determine user preferences, a user location, user requests and demographic data. The advertising content server may then perform a filtering operation by using the location data 303 and the profiles 304. As noted above, the timing and criteria used to determine when and how to fetch, download, receive or otherwise obtain the data is dependent on the connections available with the advertising content server or with the advertising content providers. Further advertising content server may create advertising options 608 to be displayed on a mobile device. Further the advertising content server displays the adverting contents 610 on the advertising application display 104.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such features may be combined with one or more other features of the other implementations as may be desired and advantageous for any given or particular application.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the invention.

1. A method for advertising on a mobile device, the method comprising:
dividing a display screen of said mobile device into a first portion containing a user initiated application display having full screen control and a second portion containing an advertising application display having limited screen control; and
using said advertising application display in said second portion according to one or more predetermined criteria to display user-specific advertising contents,
wherein, the display screen is divided into said first and second portions by a physical display driver of the display screen is configured to divide two or more logical display drivers by embedded software control to drive the contents on said first portion and said second portion independently.

2. The method of claim 1, wherein said second portion of the display screen is driven by any content by either a mobile device manufacture (MDM) or a communication service providers (CSPs) or a mobile virtual network operator (MVNO).

3. The method of claim 1, wherein said advertising content is filtered by at least one of an advertising content server located remote from said mobile device.

4. The method of claims 1 and 3, wherein said advertising content is delivered remote from the advertising content server by either the mobile device manufacture (MDM) or the communication service providers (CSPs) or the mobile virtual network operator (MVNO).

5. The method of claim 1, wherein the advertising application display can be used for monetizing by the device manufacturer or the mobile operator for advertising contents for advertisers targeting users.

6. The method of claim 1, further comprising displaying the advertising contents on the advertising application display, where initiation and duration of the advertising contents is controlled by the mobile device manufacture (MDM) or the communication service providers (CSPs) or the mobile virtual network operator (MVNO) according to the one or more predetermined criteria given the opportunity to collect direct advertising revenue.

7. The method of claim 1, further comprising providing said limited screen control on said second portion of the display screen through at least one of a skip option or a replay option.

8. A mobile device being configured for advertising contents on a display screen, comprising:
dividing a display screen of said mobile device into a first portion and a second portion;
where a physical display driver of the display screen is configured to divide into two logical display drivers by embedded software control to drive the contents on said first portion and said second portion independently; and
said first portion containing a user initiated application display having full screen control and said second portion containing an advertising application display having limited screen control,
wherein, using said advertising application display in said second portion according to one or more predetermined criteria to display user-specific advertising contents, and enabling contents from different sources to be displayed simultaneously on each portion of the display screen.

9. The mobile device of claim 8, wherein said second portion of the display screen is driven by any content by either a mobile device manufacture (MDM) or a communication service providers (CSPs) or a mobile virtual network operator (MVNO).

10. The mobile device of claim 8, wherein said advertising content is filtered by at least one of an advertising content server located remote from said mobile device.

11. The mobile device of claim 10, wherein said advertising content is delivered remote from the advertising content server by either the mobile device manufacture (MDM) or the communication service providers (CSPs) or the mobile virtual network operator (MVNO).

12. The mobile device of claim 8, wherein the advertising application display is used for monetizing by the device manufacturer or the mobile operator for advertising contents for advertisers targeting users.

13. The mobile device of claim 8, further comprising displaying the advertising contents on the advertising application display, where initiation and duration of the advertising contents is controlled by the mobile device manufacture (MDM) or the communication service providers (CSPs) or the mobile virtual network operator (MVNO) according to the one or more predetermined criteria given the opportunity to collect direct advertising revenue.

14. The mobile device of claim 8, further comprising providing said limited screen control on said second portion of display screen through a skip option or a replay option.
